(19) United States
(12) Patent Application Publication
(10) Pub. No.: US 2005/0082975 A1
(43) Pub. Date: Apr. 21, 2005

(54) Image display device and method of manufacturing the same

(76) Inventors: Akiyoshi Yamada, Tokyo (JP); Hirotaka Unno, Tokyo (JP); Masahiro Yokota, Tokyo (JP); Takashi Nishimura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/004,993

(22) Filed: Dec. 7, 2004

Related U.S. Application Data
(63) Continuation of application No. PCT/JP03/07201, filed on Jun. 6, 2003.

(30) Foreign Application Priority Data
Jun. 11, 2002 (JP) 2002-170237

(51) Int. Cl. H01J 1/62; H01J 63/04

(52) U.S. Cl. 313/512

(57) ABSTRACT

An envelope of an image display device has a rear substrate and a front substrate opposed to the rear substrate. A plurality of pixel display elements are provided inside the envelope. The front substrate and the rear substrate have respective peripheral portions thereof sealed together with a sealing material. At least one of the front substrate and the rear substrate has a seal surface reformed and sealed with the sealing material.

### CROSS-REFERENCE TO RELATED APPLICATIONS

This is a Continuation Application of PCT Application No. PCT/JP03/07201, filed Jun. 6, 2003, which was published under PCT Article 21(2) in Japanese.

This application is based upon and claims the benefit of priority from prior Japanese Patent Application No. 2002-170237, filed Jun. 11, 2002, the entire contents of which are incorporated herein by reference.

### BACKGROUND OF THE INVENTION

1. Field of the Invention

This invention relates to an image display device, having substrates opposed to each other and a large number of electron emitting elements arranged on one of the substrates, and a method of manufacturing the same.

2. Description of the Related Art

In recent years, various flat display devices have been developed as a next generation of lightweight, thin display devices to replace cathode-ray tubes (hereinafter referred to as CRT). These flat display devices include a liquid crystal display (hereinafter referred to as LCD), plasma display panel (hereinafter referred to as PDP), field emission display (hereinafter referred to as FED), surface-conduction electron emission display (hereinafter referred to as SED), etc. In the LCD, the intensity of light is controlled by utilizing the orientation of a liquid crystal. In the PDP, phosphors are caused to glow by ultraviolet rays that are produced by plasma discharge. In the FED, phosphors are caused to glow by electron beams from field-emission electron emitting elements. In the SED, phosphors are caused to glow by electron beams from surface-conduction electron emitting elements.

For example, the FED or SED generally has a front substrate and a rear substrate that are opposed to each other with a given gap between them. These substrates have their respective peripheral portions joined together by means of a sidewall in the form of a rectangular frame, thereby constituting a vacuum envelope. A phosphor screen is formed on the inner surface of the front substrate, and a large number of electron emitting elements for use as electron emitting sources that excite the phosphors to luminescence are provided on the inner surface of the rear substrate.

A plurality of support members are arranged between the rear substrate and the front substrate in order to support the atmospheric load that acts on these substrates. The potential on the rear substrate side is substantially a ground potential, and an anode voltage Va is applied to a phosphor surface. Electron beams emitted from the electron emitting elements are applied to red, green, and blue phosphors that constitute the phosphor screen, whereby the phosphors are caused to glow and display an image.

According to the FED or SED of this type, the thickness of the display device can be reduced to several millimeters. When compared with a CRT that is used as a display of an existing TV or computer, therefore, they can be made lighter in weight and thinner.

In the FED or SED described above, the interior of the envelope must be kept at a vacuum. Also in the PDP, the envelope must be filled with electric discharge gas after it is internally evacuated.

In a method of evacuating the envelope, the front substrate, rear substrate, and sidewall, which constitute the envelope, are first heated and joined with a suitable sealing material in the atmosphere. After the envelope is exhausted through an exhaust pipe that is attached to the front substrate or the rear substrate, thereafter, the exhaust pipe is vacuum-sealed. If the method of exhaust through the exhaust pipe is applied to a flat envelope, however, the exhaust speed is very low, and the attainable degree of vacuum is also low. Therefore, the mass-productivity and properties involve problems.

A method for solving these problems is described in Jpn. Pat. Appln. KOKAI Publication No. 2001-229824, for example. According to this method, a front substrate and a rear substrate that constitute an envelope is finally assembled in a vacuum tank.

In this method, the front substrate and the rear substrate that are carried into the vacuum tank are first fully heated. This is done in order to reduce gas release from the inner wall of the envelope that is the primary cause of lowering of the degree of vacuum of the envelope. When the front substrate and the rear substrate are then cooled so that the degree of vacuum in the vacuum tank is fully raised, a getter film for improving and maintaining the degree of vacuum of the envelope is formed on a phosphor screen. Thereafter, the front substrate and the rear substrate are heated again to a temperature such that a sealing material on the front substrate and/or the rear substrate melts. In this state, the front substrate and the rear substrate are combined in a predetermined position, and a seal portion is sealed with the sealing material. Thereafter, the front substrate and the rear substrate are cooled so that the sealing material solidifies.

Such a method combines a sealing process and a vacuum encapsulation process, and further, never requires much time for exhaust, so that the resulting envelope may provide a high degree of vacuum. Preferably, in this method, moreover, the sealing material used should be a low-melting metallic material that is suited for batch processing for sealing and encapsulation, e.g., indium.

If a seal surface is soiled when it is loaded with indium in each treatment process for the front substrate and the rear substrate, on the other hand, the indium is lowered in wettability on the seal surface. During sealing operation, therefore, the indium may possibly flow out from a desired seal region into another region, thereby causing leakage.

An image display device such as an SED, in particular, requires a high degree of vacuum, so that it inevitably becomes defective even if a very small part of the seal surface is subject to leakage. In order to increase the gastightness of the seal portion to enhance the reliability, the wettability of indium on the soiled seal surface must be improved.

In an example of a feasible method, the seal surface is provided with a ground layer that is formed of metal paste or the like. In this case, however, the formation of the ground layer inevitably increases the number of manufacturing processes and manufacturing cost.

### BRIEF SUMMARY OF THE INVENTION

This invention has been made in consideration of these circumstances, and its object is to provide an image display device, of which a seal portion is assured of high gastightness and improved reliability, and a method of manufacturing the same.

In order to achieve the object, according to an aspect of the invention, an image display device comprises an envelope, which has a rear substrate and a front substrate opposed to the rear substrate, and a plurality of pixel display elements provided inside the envelope, the front substrate and the rear substrate having respective peripheral portions thereof sealed together with a sealing material, and at least one of seal surface of the front substrate and the rear substrate, which are sealed together with the sealing material, being reformed.

According to another aspect of the invention, in a method of manufacturing an image display device comprising an envelope, which has a rear substrate and a front substrate opposed to the rear substrate, and a plurality of pixel display elements provided inside the envelope, the front substrate and the rear substrate having respective peripheral portions thereof sealed together with a sealing material, the method comprises reforming a seal surface of at least one of the front substrate and the rear substrate; and after applying the sealing material on the reformed seal surface, sealing the respective peripheral portions of the front substrate and the rear substrate together with the sealing material.

With the image display device and the method of manufacturing the same described above, the seal surface is reformed into an activated clean surface. Thereupon, the wettability of the sealing material on the seal surface is improved, so that the sealing material can be prevented from flowing out from the seal surface even when the sealing material is melted during the sealing operation. Thus, an image display device with improved gastightness and reliability can be obtained in which leakage through a seal portion is prevented.

### BRIEF DESCRIPTION OF THE SEVERAL VIEWS OF THE DRAWING

FIG. 1 is a perspective view showing an FED according to an embodiment of this invention;

FIG. 2 is a perspective view showing the FED with its front substrate removed;

FIG. 3 is a sectional view taken along line III-III of FIG. 1;

FIG. 4 is a plan view showing a phosphor screen of the FED;

FIG. 5 is a sectional view showing a state in which indium layers are formed individually on a seal surface of the front substrate and a seal surface of a sidewall constituting a vacuum envelope of the FED;

FIG. 6 is a diagram schematically showing a vacuum processor used in the manufacture of the FED;

FIG. 7 is a diagram showing results of comparison of the wettability of indium during vacuum heating between a case where the seal surfaces were reformed by chemical and physical polishing or heat treatment and a case where the seal surfaces were not reformed; and

FIG. 8 is a sectional view showing a state in which an indium layer is formed on a seal surface of a front substrate and a seal surface of a sidewall constituting a vacuum envelope, in a manufacturing method for an FED according to another embodiment of this invention.

### DETAILED DESCRIPTION OF THE INVENTION

Embodiments in which an image display device of this invention is applied to an FED will now be described in detail with reference to the drawings.

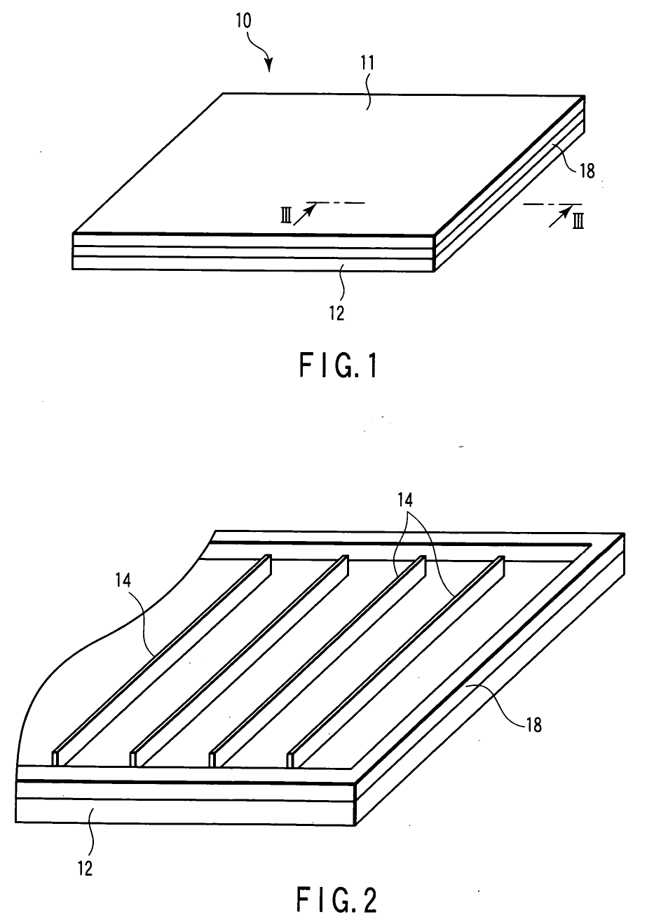

As shown in FIGS. 1 to 3, the FED comprises a front substrate 11 and a rear substrate 12, which are formed of a rectangular glass structure as an insulating substrate each. These substrates are opposed to each other with a gap of about 1.5 to 3.0 mm between them. The front substrate 11 and the rear substrate 12 have their respective peripheral edge portions joined together by means of a sidewall 18 in the form of a rectangular frame, and constitute a flat, rectangular vacuum envelope 10 that maintains a vacuum within.

A plurality of plate-like support members 14, which support an atmospheric load that acts on the rear substrate 12 and the front substrate 11, are arranged in the vacuum envelope 10. These support members 14 extend parallel to the short sides of the vacuum envelope 10 and are arranged at given spaces along a direction parallel to the long sides. The support members 14 are not limited to the plate-like shape, and columnar support members may be used instead.

As shown in FIG. 4, a phosphor screen 16 is formed on the inner surface of the front substrate 11. The phosphor screen 16 is formed by arranging stripe-shaped phosphor layers R, G and B, which glows in three colors, red, blue, and green, respectively, and a striped light absorbing layer as a non-luminous portion situated between the phosphor layers. The phosphor layers R, G and B extend parallel to the short sides of the vacuum envelope 10 and are arranged at given spaces along a direction parallel to the long sides. An aluminum layer (not shown) is formed as a metal back on the phosphor screen 16 by vapor deposition.

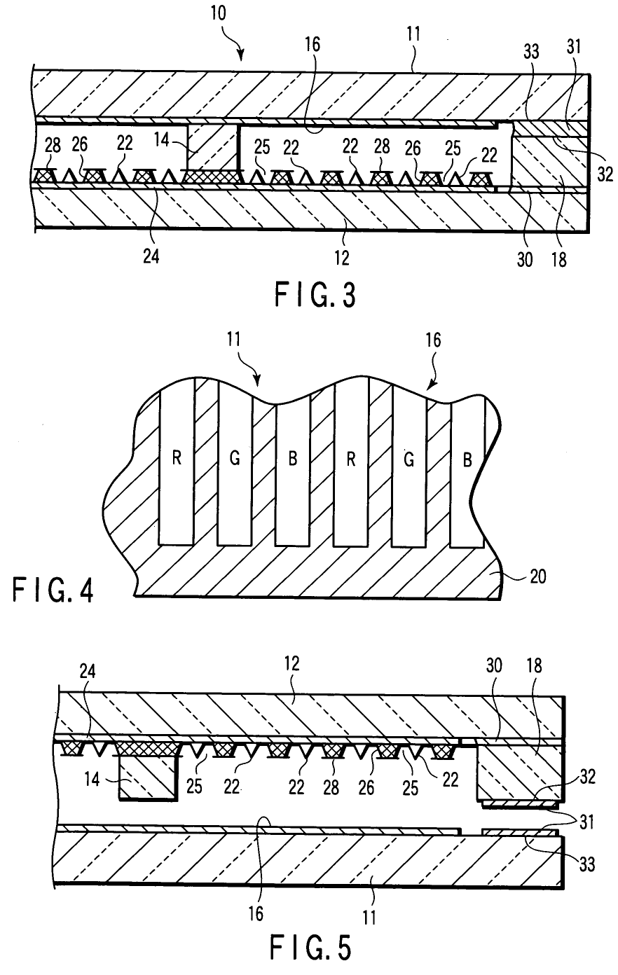

As shown in FIG. 3, a large number of electron emitting elements 22 are arranged on the inner surface of the rear substrate 12. They serve as electron emitting sources that excite the phosphor layers R, G and B. The electron emitting elements 22 are formed as field-emission electron emitting elements that individually emit electron beams. These electron emitting elements 22 that constitute pixel display elements are arranged in a plurality of columns and a plurality of rows corresponding to individual pixels.

More specifically, an electrically conductive cathode layer 24 is formed on the inner surface of the rear substrate 12. A silicon dioxide film 26 having a large number of cavities 25 are formed on the electrically conductive cathode layer. Gate electrodes 28 of molybdenum, niobium or the like are formed on the silicon dioxide film 26. On the inner surface of the rear substrate 12, the conical electron emitting elements 22 of molybdenum or the like are provided in the cavities 25, individually. Further, a large number of wires for supplying potential to the electron emitting elements 22 are arranged in a matrix on the rear substrate 12.

In the FED constructed in this manner, video signals are applied to the electron emitting elements 22 and the gate electrodes 28 that are formed in a simple matrix. A gate voltage of +100 V is applied to the electron emitting elements 22 as a reference when in a highest-luminance state. A voltage of +10 kV is applied to the phosphor screen 16. Electron beams emitted from the electron emitting elements 22 are modulated by the voltage of the gate electrodes 28. These electron beams excite the phosphor layers of the phosphor screen 16 to emit light. Thereupon, an image is displayed.

Since the high voltage is thus applied to the phosphor screen 16, the front substrate 11, rear substrate 12, sidewall 18, and support members 14 are formed of high-strain glass. As described later, the space between the rear substrate 12 and the sidewall 18 is sealed with low-melting glass 30, such as fritted glass. The space between the front substrate 11 and the sidewall 18 is sealed with indium layers 31 that contain indium (In) as a low-melting sealing material. The indium layers 31 are each formed like a belt that extends as a rectangular frame along the sidewall 18.

The following is a detailed description of a method of manufacturing the FED constructed in this manner.

First, the phosphor screen 16 is formed on a sheet glass to be used as the front substrate 11. A sheet glass as large as the front substrate 11 is prepared, and stripe patterns of the phosphor layers are formed on the sheet glass by means of a plotter machine. The sheet glass that has the phosphor stripe patterns formed thereon and the sheet glass for the front substrate are put on a positioning tool and set on an exposure table. In this state, they are subjected to exposure and development, whereupon the phosphor screen is formed on the sheet glass to be used as the front substrate 11. Thereafter, the metal back is formed on the phosphor screen 16 in a superposed manner.

Subsequently, the electron emitting elements 22 are formed on the sheet glass for the rear substrate. In this case, the matrix-shaped electrically conductive cathode layer is formed on the sheet glass, and the silicon dioxide film, an insulating film, is formed on the electrically conductive cathode layer by the thermal oxidation method, CVD method, or sputtering method, for example.

Thereafter, a metal film of molybdenum or niobium for gate electrode formation is formed on the insulating film. Then, a resist pattern of a shape corresponding to the gate electrodes to be formed is formed on the metal film by lithography. The metal film is etched to form the gate electrodes 28 by the wet etching method or dry etching method using the resist pattern as a mask.

Then, the insulating film is etched to form the cavities 25 by the wet etching method or dry etching method using the resist pattern and the gate electrode as masks. After the resist pattern is removed, a release layer of, e.g., aluminum or nickel is formed on the gate electrodes 28 by vapor deposition with electron beams applied in a direction inclined at a given angle to the surface of the rear substrate. Thereafter, molybdenum, for example, is deposited as a material for cathode formation on the surface of the rear substrate in a direction perpendicular thereto by the electron-beam vapor deposition method. By doing this, the electron emitting elements 22 are formed in the cavities 25, individually. Subsequently, the release layer, along with the metal film thereon, is removed by the lift-off method.

Then, the peripheral edge portion of the rear substrate 12 having the electron emitting elements 22 thereon and the rectangular frame-shaped sidewall 18 are sealed together with the low-melting glass 30 in the atmosphere, as shown in FIG. 5.

Thereafter, the rear substrate 12 and the front substrate 11 are sealed together with the sidewall 18 between them. In this case, the upper surface of the sidewall 18 and the peripheral edge portion of the inner surface of the front substrate 11, which form seal surfaces 32 and 33, respectively, are first subjected to physical polishing, chemical polishing, or heat treatment. By doing this, the seal surfaces 32 and 33 are reformed into clean surfaces and improved in wettability of indium. Subsequently, indium is applied to the seal surfaces 32 and 33, whereupon the rectangular frame-shaped indium layers 31 are formed individually extending throughout the circumference.

Preferably, the sealing material used should be a low-melting metallic material that has a melting point of 350° C. or below and is high in adhesion and joining properties. The indium (In) used in present embodiment is characterized in that its melting point is low at 156.7° C., and further, that its vapor pressure is low and it cannot be rendered fragile even at low temperature.

Also available as the low-melting metallic material, in place of simple In, is an alloy that is obtained by doping In singly or in combination with at least one of elements including Ag, Ni, Co, Au, Cu, Sn, Bi and Zn. For example, an eutectic alloy of 97%-In and 3%-Ag has a lower melting point of 141° C., and its mechanical strength can be enhanced.

Although the expression “melting point” is used in the above description, the melting point may fail to be set at a single value for some alloys that are composed of two or more types of metals. Generally, a liquidus temperature and a solidus temperature are defined in such a case. The former is a temperature at which part of an alloy starts to solidify as the temperature for a liquid state is lowered. The latter is a temperature at which an entire alloy solidifies. For ease of description, in the present embodiment, the expression “melting point” is also used in this case, and the solidus temperature referred to as the melting point.

Then, the front substrate 11, having the indium layer 31 formed on its seal surface 33, and a rear-side assembly, in which the sidewall 18 is sealed to the rear substrate 12 and the indium layer 31 is formed on the upper surface of the sidewall 18, that is, the seal surface 32, are held by means of a jig or the like with the seal surfaces opposed to each other and spaced, as shown in FIG. 5, and are put into a vacuum processor.

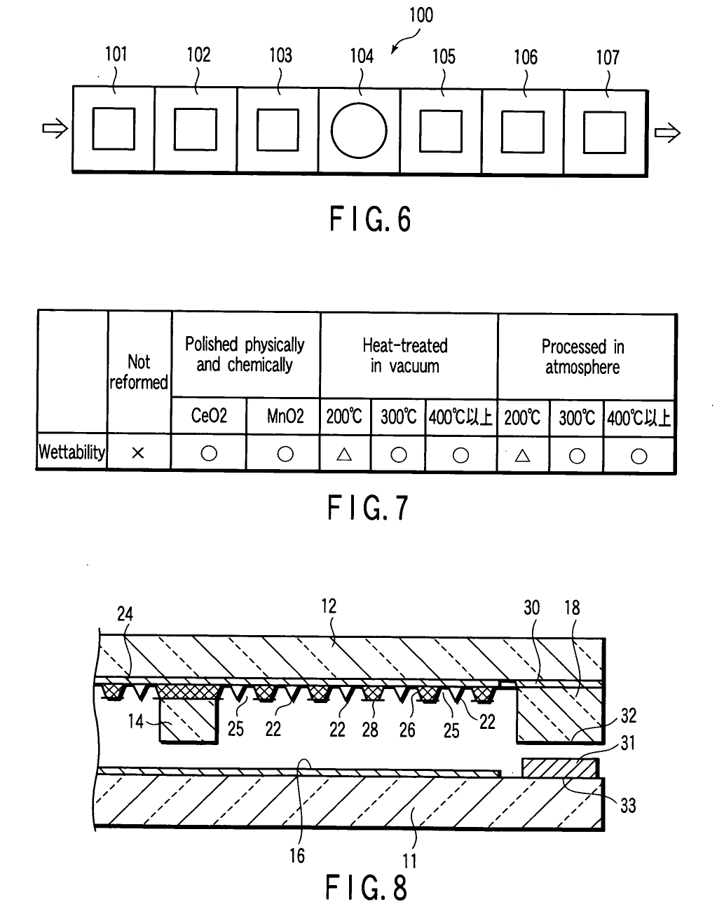

As shown in FIG. 6, a vacuum processor 100 has a loading chamber 101, baking and electron-beam cleaning chamber 102, cooling chamber 103, vapor deposition chamber 104 for getter film, assembly chamber 105, cooling chamber 106, and unloading chamber 107, which are successively arranged side by side. These chambers are formed as processing chambers capable of vacuum processing, and all the chambers are exhausted to a vacuum during the manufacture of the FED. Each two adjacent processing chambers are connected by a gate valve or the like.

The rear-side assembly and the front substrate 11, which are opposed and spaced, are put into the loading chamber 101. They are delivered to the baking and electron-beam cleaning chamber 102 after a vacuum atmosphere is formed in the loading chamber 101. When a high degree of vacuum of about 10⁻⁵ Pa is reached in the baking and electron-beam cleaning chamber 102, the rear-side assembly and the front substrate 11 are heated to a temperature of about 300° C. and baked, and a gas that is adsorbed by the respective surfaces of the individual members is thoroughly discharged.

In the baking and electron-beam cleaning chamber 102, moreover, electron beams from an electron beam generator (not shown) are applied to the phosphor screen surface of the front substrate 11 and an electron emitting element surface of the rear substrate 12 as the heating is performed. The electron beams are deflected for scanning by a deflector that is attached to the outside of the electron beam generator. Thus, the phosphor screen surface and the electron emitting element surface are wholly subjected to electron-beam cleaning.

After the heating and the electron-beam cleaning, the rear-substrate-side assembly and the front substrate 11 are delivered to the cleaning chamber 103 and cooled to a temperature of about 100° C., for example. Subsequently, the rear-side assembly and the front substrate 11 are delivered to the vapor deposition chamber 104, whereupon a Ba film as a getter film is formed on the outer surface of the phosphor screen by vapor deposition. The surface of the Ba film can be prevented from being soiled by oxygen or carbon and is kept active.

Then, the rear-side assembly and the front substrate 11 are delivered to the assembly chamber 105, where it is heated to 200° C. Thereupon, the indium layers 31 are melted into a liquid state or softened again. In this state, the front substrate 11 and the sidewall 18 are joined and pressurized under a given pressure, and indium is slowly cooled and solidified. Thus, the front substrate 11 and the sidewall 18 are sealed together with the indium layers 31, whereupon the vacuum envelope 10 is formed.

After the vacuum envelope 10 formed in this manner is cooled to normal temperature in the cooling chamber 106, it is taken out of the unloading chamber 107. Thereafter, the FED is completed after various subsequent processes are carried out.

According to the FED constructed in this manner and the method of manufacturing the FED, the gas that is adsorbed by the respective surfaces of the substrates and the sidewall can be thoroughly discharged by sealing the front substrate 11 and the rear substrate 12 together in a vacuum atmosphere and combining the baking and the electron-beam cleaning. At the same time, the getter film can maintain a good gas adsorption effect without being oxidized. Thus, the resulting FED can maintain a high degree of vacuum. Since indium is used as the sealing material, moreover, a highly gastight FED can be obtained without suffering any blowing in a vacuum, a problem associated with fritted glass.

If the indium layer formed on the unprocessed seal surfaces 32 and 33 is heated to, e.g., 300° C. in a vacuum so that indium melts, the indium is bound to be repelled by the seal surfaces. This is because the wettability of indium is lowered by residual impurities on the seal surfaces 32 and 33. As mentioned before, therefore, the impurities on the seal surfaces 32 and 33 are removed by polishing the seal surfaces 32 and 33 with CeO₂, which is a chemical and physical abrasive. Thereupon, the seal surfaces 32 and 33 are reformed into clean surfaces and improved in wettability of indium. Thus, the indium ceases to be repelled even during vacuum heating, so that leakage through a seal portion can be prevented. In consequence, a highly gastight vacuum envelope can be obtained.

The abrasive is not limited to CeO₂, and may be any material that has chemical and physical polishing effects. For example, MnO₂, Mn₂O₃, Mn₃O₄, etc. may be used. The chemical polishing and physical polishing are not limited to the processing of the seal surfaces 32 and 33, and the whole inner surface of the front substrate 11 or the rear substrate 12 may be polished.

Further, the seal surfaces 32 and 33 may be reformed by heat-treating the seal surfaces or the entire substrates at 200° C. or above, preferably at 300° C. or above, in a vacuum or in the atmosphere, instead of by being subjected to chemical polishing and physical polishing.

The wettability of indium during vacuum heating was tested for the case where the seal surfaces were reformed by the aforesaid chemical and physical polishing or heat treatment, compared with the case where the seal surfaces were not reformed. FIG. 7 shows results of the test. In FIG. 7, X indicates lowering of wettability, Δ indicates the possibility of leakage caused by lowering of wettability more limited than without a reforming process, and ◯ indicates good wettability.

When the seal surfaces were polished, as seen from this diagram, good wettability was able to be obtained with use of any of the abrasives. Good wettability was obtained at 200° C., preferably at 300° C., in either of the heat treatments in a vacuum and in the atmosphere.

Thus, the wettability of indium on the seal surfaces can be considerably improved by heat-treating the seal surfaces so that they are reformed into clean surfaces. Thus, there is no possibility of the indium from flowing out from a desired seal region during sealing operation, so that a seal structure with high gastightness and reliability can be realized even for a large-sized FED of 50 inches or more.

This invention is not limited to the embodiment described above, and various modifications may be effected therein without departing from the scope of the invention. For example, the electron emitting elements are not limited to field-emission electron emitting elements, and may alternatively be any other electron emitting elements, such as pn-type cold cathode elements or surface-conduction electron emitting elements. Also, this invention is applicable to other image display devices, such as a plasma display panel (PDP), electroluminescence (EL), etc.

In the foregoing embodiment, the front substrate 11 and the sidewall 18 are sealed together with the indium layers 31 that are formed individually on their respective seal surfaces 33 and 32. As shown in FIG. 8, however, a front substrate and a sidewall 18 may be sealed together with an indium layer 31 formed only on a seal surface 33 of a front substrate 11, for example. Further, the space between the peripheral edge portion of a rear substrate 12 and the sidewall 18 may be sealed with a metallic sealing material such as indium. In this case, the two should only be sealed together after the peripheral edge portion of the inner surface of the rear substrate 12, as a seal surface, is reformed in the same manner as in the foregoing embodiment.

1. An image display device comprising an envelope, which has a rear substrate and a front substrate opposed to the rear substrate, and a plurality of pixel display elements provided inside the envelope,
the front substrate and the rear substrate having respective peripheral portions thereof sealed together with a sealing material, at least one of the front substrate and the rear substrate having a seal surface reformed and sealed with the sealing material.

2. The image display device according to claim 1, wherein the sealing material is a low-melting metallic material.

3. The image display device according to claim 2, wherein the low-melting metallic material is In or an alloy containing In.

4. The image display device according to claim 3, wherein the alloy containing In contains at least one of elements including Ag, Ni, Co, Au, Cu, Sn, Bi and Zn.

5. The image display device according to claim 1, wherein the seal surface is a reformed surface polished with a chemical or physical abrasive.

6. The image display device according to claim 5, wherein the seal surface is a reformed surface polished with CeO₂, MnO₂, Mn₂O₃, or Mn₃O₄.

7. The image display device according to claim 1, wherein the seal surface is a reformed surface heat-treated at 200° C. or above.

8. A method of manufacturing an image display device comprising an envelope, which has a rear substrate and a front substrate opposed to the rear substrate, and a plurality of pixel display elements provided inside the envelope, the front substrate and the rear substrate having respective peripheral portions thereof sealed together with a sealing material, the method comprising:
reforming a seal surface of at least one of the front substrate and the rear substrate; and
after applying the sealing material on the reformed seal surface, sealing the respective peripheral portions of the front substrate and the rear substrate together with the sealing material.

9. The method of manufacturing an image display device according to claim 8, wherein the reforming the seal surface includes polishing the seal surface with one of abrasives including CeO₂, MnO₂, Mn₂O₃, and Mn₃O₄.

10. The method of manufacturing an image display device according to claim 8, wherein the reforming the seal surface includes heating the seal surface at 200° C. or above.

11. The method of manufacturing an image display device according to claim 8, wherein the sealing material is a low-melting metallic material.

12. The method of manufacturing an image display device according to claim 11, wherein the low-melting metallic material is In or an alloy containing In.
